(19) United States
(12) Patent Application Publication
(10) Pub. No.: US 2026/0140004 A1
(43) Pub. Date: May 21, 2026

(54) ROLLER GROOVE FOR TENSION DEVICE

(71) Applicant: Schlumberger Technology Corporation, Sugar Land, TX (US)

(72) Inventors: Antonio Mauricio Cevallos Navarrete, Sugar Land, TX (US); Joseph Varkey, Sugar Land, TX (US); Muhammad Usman, Sugar Land, TX (US); Sheng Chang, Sugar Land, TX (US); Jeffrey Joseph Kamps, Sugar Land, TX (US); Taysir Salim, Sugar Land, TX (US); Jared M. Mangum, Sugar Land, TX (US); Rafia Saif, Sugar Land, TX (US); Tam Tran, Sugar Land, TX (US)

(21) Appl. No.: 19/395,145

(22) Filed: Nov. 20, 2025

Related U.S. Application Data
(60) Provisional application No. 63/722,739, filed on Nov. 20, 2024.

(51) Int. Cl. G01L 5/107

(52) U.S. Cl. CPC G01L 5/107

(57) ABSTRACT

A roller for use in a tension measuring device may include a groove with a groove size, an opening angle, and a depth of a specific range. The roller further comprises a contact angle with a specific range between a cable outer diameter and a cable inner diameter of the roller groove.

### CROSS-REFERENCE TO RELATED APPLICATIONS

The current disclosure claims priority to U.S. Provisional Patent Application 63/722,739 filed Nov. 20, 2024, the entirety of which is incorporated by reference.

### FIELD OF THE DISCLOSURE

Aspects of the disclosure relate to wireline cables. More specifically, aspects of the disclosure relate to tension devices used in operating wireline cables.

### BACKGROUND

Wireline cables are used in the oil and gas industry to convey downhole tools and provide the necessary electrical power and telemetry communication to operate downhole tools. When a cable is deployed and/or retrieved into the well, cable weight, hydrostatic pressure, induced pumping pressures and dragging forces are exerted on the cable.

Surface cable tension is critical during the operations and as such, needs to be monitored at all times and precisely measured so that cable is maintained within design specifications. Traditionally, wireline oil and gas service companies use tension measuring devices to accomplish cable tension measurements without inducing harm to the cable and data recording equipment. A tension device can be installed on surface equipment or mounted directly to the cable section that is accessible between the winch containing the spooled cable, sheaves to guide the cable and the well pressure control equipment stack up, as shown in FIG. 1. In this FIG., downhole tools 102 are suspended within a well 104. The amount and type of downhole tools 102 may vary; therefore, the overall weight supported may vary. Pressure control equipment 106 may also be suspended from the cable 108 that transfers weight through sheaves 110 supported by a crane 112. A tension measuring device 114 is located down after a second set of sheaves 116 prior to motive action by a winch with spooled cable 118.

These tension devices have rollers that are installed on the device to guide the cable while passing through the tension device and to induce a force against the cable. The cable reaction force, which occurs as a result of such induced force, is monitored through load cells mounted on the tension device. This force is then correlated to an actual cable tension reading. Typically, the induced force on cable can be generated by 1) deflecting the cable under tension through three or more rollers configuration shown in FIG. 2, or 2) a capstan style wheel configuration, as seen in FIG. 3. Referring to FIG. 2, a first roller 202 is located at a left end, followed by a center roller 204 and a third roller 206. The cable 208 is passed between the rollers 202, 204, 206. A load cell 210 is located on the center roller 204. Referring to FIG. 3, a cable 302 stretches between a first roller 304 and a second roller 306. A load cell 308 is placed on one of the rollers to measure the amount of force (F) which can be converted to the overall tension (T) in the cable 308.

Tension devices are standard and common products used in wireline operations. The challenge with these types of devices is to understand the impact that such equipment has regarding the service life of the cable. The effects on service life are often underestimated, and improper design of rollers induce issues on the cable such flattening, damage on outer jacket for polymer jacketed cables, localized stress concentration on armor wires with possible armor wire breaks. All of these issues may result in damage or a parted cable.

A proper groove design, specifically for handling wireline cables, is critical to prevent such issues, maintaining higher safe working load and to prolong the life expectancy of the wireline cable; however, conventional designs do not provide the advantages needed by the industry.

There is a need to provide an improved groove design that does not impact the service life of cables.

There is a further need to provide an improved groove design that is easy to manufacture and operate.

There is a still further need to provide an improved design that is economical to produce compared to conventional apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 is a typical equipment configuration with cable deployed and monitoring of surface tension with a tension device, according to one or more examples of the disclosure.

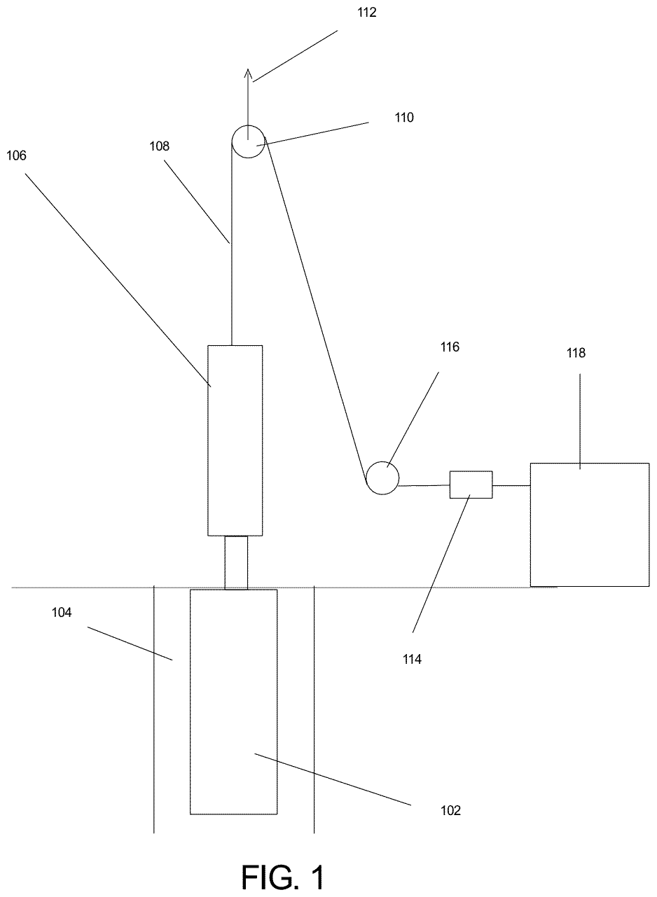

FIG. 2 is a diagram illustrating a cable deflection and induced force relative to load cell, according to one or more examples of the disclosure.

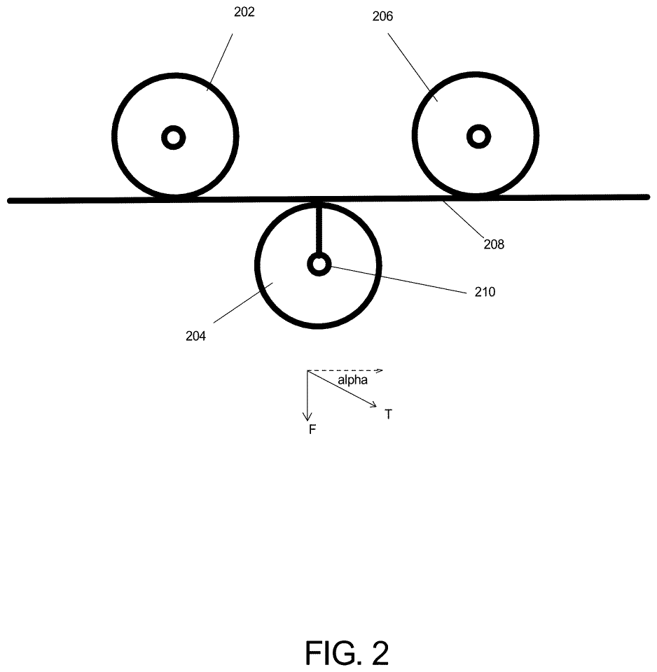

FIG. 3 is a diagram illustrating a capstan style cable tension measuring device, according to one or more examples of the disclosure.

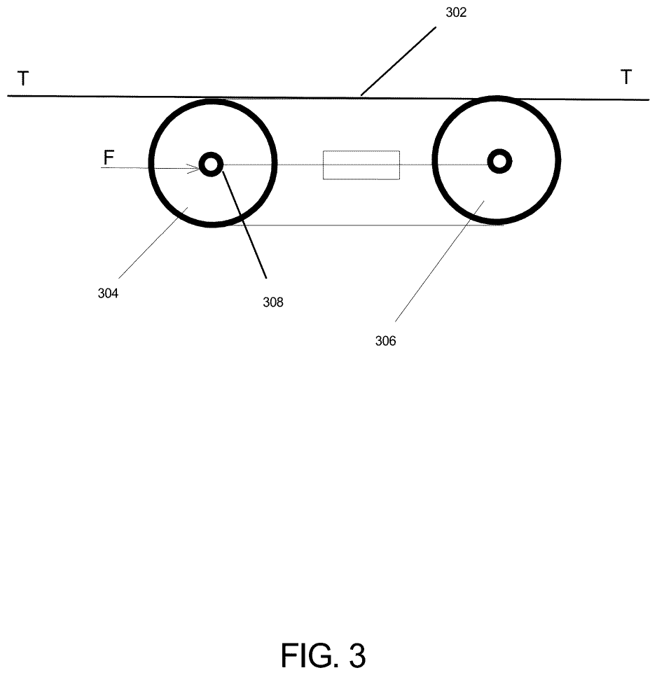

FIG. 4 is a diagram illustrating groove design specifications, according to one or more examples of the disclosure.

FIG. 5 is a diagram illustrating cable versus groove diameter, according to one or more examples of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a tension measuring device is disclosed. The device may comprise a first roller and a second roller; the first roller and the second roller each having a body wherein a groove size is provided as one of follows:

$$( Cable OD - {0.007}^{″} ) \leq a \leq ( Cable OD + {0.03}^{″} ) ,$$

$$( 0.1 * Cable OD ) , ( Cable OD - {0.007}^{″} ) \leq a \leq ( Cable OD ) .$$

The device may further comprise a load cell connected between the first roller and the second roller.

In another example embodiment, a tension measuring device is disclosed. The tension measuring device may comprise a first roller and a second roller. The tension measuring device may also comprise a third roller, the first roller, the second roller and the third roller each having a body wherein a groove size is provided as one of follows:

$$( Cable OD - {0.007}^{″} ) \leq a \leq ( Cable OD + {0.03}^{″} ) , ( 0.1 * Cable OD ) ,$$

$$( Cable OD - {0.007}^{″} ) \leq a \leq ( Cable OD ) ;$$

and a load cell connected between the first roller and the second roller wherein the value a is an inner groove diameter.

In another example embodiment, a roller is described. The roller may comprise a body configured in a round shape, the body having an external edge with a groove, the groove having a size according to one of

$$( Cable OD - {0.007}^{″} ) \leq a \leq ( Cable OD + {0.03}^{″} ) ,$$

$$( 0.1 * Cable OD ) , ( Cable OD - {0.007}^{″} ) \leq a \leq ( Cable OD ) ;$$

and wherein a is an inner groove diameter.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers, and/or sections, these elements, components, regions, layers, and/or sections should not be limited by these terms. These terms may be only used to distinguish one element, components, region, layer, or section from another region, layer, or section. Terms such as “first”, “second”, and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on”, “engaged to”, “connected to”, or “coupled to” another element or layer, it may be directly on, engaged, connected, or coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure provide a method of designing roller grooves specific to the cable outer diameter (OD) of a smooth jacketed wireline cable. Such grooves should provide adequate support to the outer jacket to prevent cold flow on either side of the contact point.

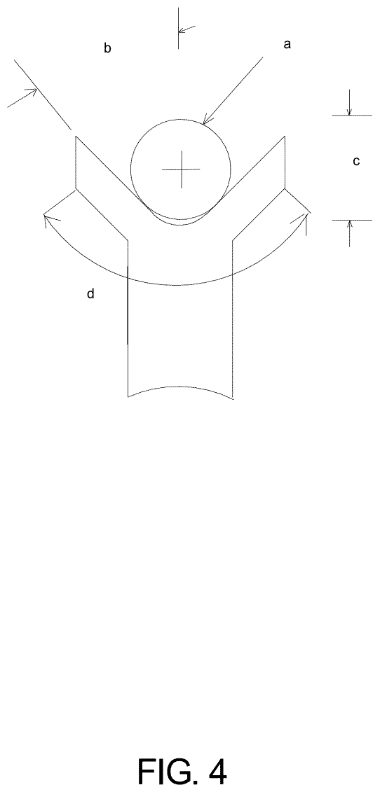

In one embodiment, the inner diameter of the groove is calculated using EQ.1, which is based on the outer diameter of the cable to be used with these devices. The inner diameter of the groove represented by the value “a” in FIG. 4, has a positive unilateral tolerance of 0.030 inches or 10 percent of the outer diameter of the cable, whichever is larger. Embodiments may also have a negative unilateral tolerance of 0.007 inches to the nominal outer diameter of the cable.

$$( Cable OD - {0.007}^{″} ) \leq a \leq ( Cable OD + {0.03}^{″} ) or \qquad ( EQ . 1 )$$

$$( 0.1 * Cable OD )$$

For smooth jacketed cable, the inner diameter of the groove a may be equal to the cable OD or less than 0.007 inches of the nominal outer diameter of the cable, which is shown in EQ. 2.

$$( Cable OD - {0.007}^{″} ) \leq a \leq ( Cable OD ) \qquad ( EQ . 2 )$$

In one embodiment, the rim of the rollers should have an opening angle between 0 to 60 degrees, as indicated in EQ. 3. This is to compensate for any fleet angle of the cable. This opening angle is described as “b” in the FIG. 4 below:

$$0 ° \leq b \leq 60 ° . \qquad ( EQ . 3 )$$

In one embodiment, the depth of the groove is calculated using EQ. 4, by measuring the distance between the inner surface of the groove and the top edge of the rim. It is represented as “d” in FIG. 4. It should be deep enough for the cable to sit properly in the groove.

$$( 0.4 * Cable OD ) \leq c \leq ( 2 * Cable OD ) \qquad ( EQ . 4 )$$

For smooth jacketed cable, the most preferred depth of the groove must be between 80 percent to 120 percent of the cable outer diameter.

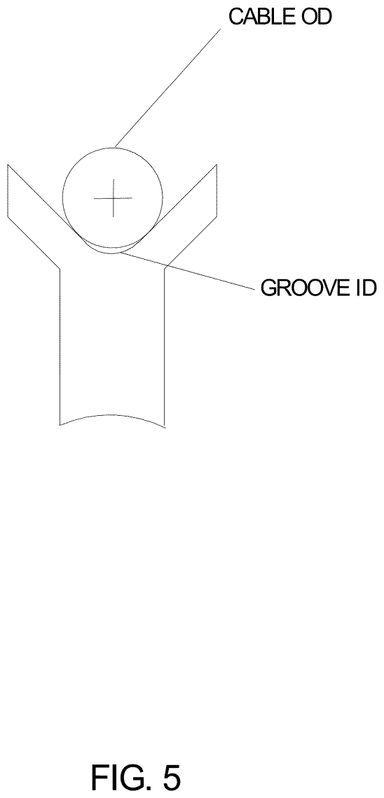

In one embodiment, the grooves should be designed in such a way the cable circumference should have a contact angle of greater than 100 degrees with the groove inner diameter. This is defined as “d” in FIG. 4 and indicated in EQ. 5 below. The contact angle is further illustrated in FIG. 5, which is between a cable outer diameter and a cable inner diameter of the roller groove.

$$100 ° \leq d \leq 180 ° \qquad ( EQ . 5 )$$

For smooth jacketed cable, the preferred contact angle is 120 to 180 degrees.

Wireline operations are critical to the exploration and production of hydrocarbons, serving as the backbone for well intervention, logging, and completion tasks in the oil and gas industry. A key aspect of successful wireline deployment is the precise control and measurement of cable tension. Tension devices, specifically designed for wireline applications, play a pivotal role in ensuring operational safety, efficiency, and equipment longevity. This essay discusses the various types of tension devices used in wireline operations, their mechanical design considerations, and their significance in hydrocarbon recovery.

Wireline refers to a set of cabling technologies used to lower equipment or measurement devices into wells. These operations enable engineers to gather vital downhole data, perform maintenance, and execute complex recovery strategies. The wireline cable, often subjected to substantial forces due to gravity, friction, and wellbore pressure, must be managed with utmost precision. Inadequate tension control can result in cable damage, tool loss, or compromised data quality, highlighting the necessity for robust tension measuring and controlling devices.

The primary tension devices used in wireline operations include tension measuring rollers, load cells, and electronic tension monitoring systems. Each device is engineered to measure and regulate the force exerted on the wireline cable, ensuring its structural integrity throughout the operation.
Tension Measuring Rollers: These are mechanical devices where the wireline cable runs over specially designed rollers equipped with grooves. The groove geometry is meticulously calculated to match the cable's outer diameter (OD), as illustrated in the provided equations and descriptions. For smooth jacketed cables, the groove's inner diameter is typically equal to or slightly less than the cable OD, ensuring optimal fit and minimizing slippage. The groove depth, opening angle, and contact angle are also tailored to enhance cable engagement and distribute tension evenly. Such precision in design allows for accurate tension readings and reduces the risk of cable wear or failure.
Load Cells: These electronic or hydraulic sensors are integrated into the wireline sheave or drum assembly. As the cable passes through or over the load cell, the device measures the real-time force applied. Load cells offer high sensitivity and can be calibrated to trigger alarms or automatic shutoffs if tension exceeds safe thresholds.
Electronic Tension Monitoring Systems: Modern wireline units often include advanced electronic systems that continuously monitor cable tension, display data graphically, and record tension profiles for post-operation analysis. These systems may integrate with other operational controls, enabling automated responses to tension anomalies.

The effectiveness of tension devices in wireline operations depends largely on their mechanical design and compatibility with the cable type. For example, the groove of the tension measuring roller must be engineered with precise tolerances. As described in the context, the inner diameter should closely match the cable OD, and the groove depth should be sufficient to cradle the cable securely without excessive compression. The opening angle (typically 0 to 60 degrees) accommodates fleet angles—the deviation of the cable from a straight path—ensuring consistent contact and accurate measurements. Additionally, the contact angle between the cable and groove should exceed 100 degrees, with a preferred range of 120 to 180 degrees for smooth jacketed cables, maximizing grip, and reducing the likelihood of cable jump or misalignment.

Material selection for rollers and load cells is also critical, as these components must withstand harsh wellsite environments, including exposure to drilling fluids, high pressures, and varying temperatures. Surface finishes and coatings may be applied to minimize friction and corrosion, further enhancing device reliability.

Effective tension management is directly linked to the safety and success of wireline operations. Over-tensioning can lead to cable stretching, deformation, or breakage, potentially resulting in costly fishing operations to retrieve lost tools. Under-tensioning, conversely, may cause cable slack, entanglement, or improper tool positioning. By providing real-time feedback and control, tension devices help operators maintain optimal conditions, safeguarding both personnel and equipment. Furthermore, precise tension data enables operators to make informed decisions regarding pull rates, logging speeds, and tool deployment, directly influencing the quality and reliability of downhole measurements. In complex hydrocarbon recovery scenarios, such as deviated or high-pressure wells, the role of tension devices becomes even more pronounced, as they help navigate operational risks and maximize resource extraction.

Tension devices are indispensable to wireline operations in hydrocarbon recovery, ensuring that cables are managed safely and efficiently under challenging conditions. Through innovative mechanical design and integration of advanced monitoring technologies, these devices enable precise tension control, enhance operational reliability, and contribute to the overall success of well interventions. As the industry evolves, continued advancements in tension device technology will further support the quest for safer and more productive hydrocarbon extraction.

Aspects of the disclosure provide an improved groove design that does not impact the service life of cables.

Aspects of the disclosure also provide an improved groove design that is easy to manufacture and operate.

Aspects of the disclosure also provide an improved design that is economical to produce compared to conventional apparatus.

Example embodiments of the claims are described next. The disclosure of these recited claims should not be considered limiting. In one example embodiment, a tension measuring device is disclosed. The device may comprise a first roller and a second roller, the first roller and the second roller each having a body wherein a groove size is provided as one of follows:

$$( Cable OD - 0.007 ” ) \underline{<} a \underline{<} ( Cable OD + 0.03 ” ) , ( 0.1 * Cable OD ) , ( Cable OD - 0.007 ” ) \underline{<} a \underline{<} ( Cable OD ) .$$

The device may further comprise a load cell connected between the first roller and the second roller.

In another example embodiment, the tension measuring device may be configured wherein the first roller and the second roller are configured to be used with a smooth jacketed cable.

In another example embodiment, the tension measuring device may be configured wherein an opening angle of the groove is as follows:

$$0 ° \leq b \leq 60 ° .$$

In another example embodiment, the tension measuring device may be configured wherein a depth of the roller groove is as follows:

$$( 0.4 * Cable OD ) \leq c \leq ( 2 * Cable OD ) .$$

In another example embodiment, the tension measuring device may be configured wherein a depth of the roller groove when used in the smooth jacketed cable is as follows:

$$( 0.8 * Cable OD ) \leq c \leq ( 1.2 * Cable OD ) .$$

In another example embodiment, the tension measuring device may be configured wherein a contact angle between a cable outer diameter and a cable inner diameter of the roller groove is as follows:

$$100 ° \leq d \leq 180 ° .$$

In another example embodiment, the tension measuring device may be configured wherein a contact angle between a cable outer diameter and a cable inner diameter of the roller groove when used in the smooth jacketed cable is as follows:

$$120 ° \leq d \leq 180 ° .$$

In another example embodiment, a tension measuring device is disclosed. The tension measuring device may comprise a first roller and a second roller. The tension measuring device may also comprise a third roller, the first roller, the second roller and the third roller each having a body wherein a groove size is provided as one of follows:

$$( Cable OD - 0.007 ” ) \underline{<} a \underline{<} ( Cable OD + 0.03 ” ) , ( 0.1 * Cable OD ) , ( Cable OD - 0.007 ” ) \underline{<} a \underline{<} ( Cable OD ) ;$$

and a load cell connected between the first roller and the second roller wherein the value a is an inner groove diameter.

In another example embodiment, the tension measuring device may be configured wherein the first roller and the second roller are configured to be used with a smooth jacketed cable.

In another example embodiment, the tension measuring device may be configured wherein an opening angle of the groove is as follows:

$$0 ° \leq b \leq 60 °$$

where b is the opening angle.

In another example embodiment, the tension measuring device may be configured wherein a depth of the roller groove is as follows:

$$( 0.4 * Cable OD ) \leq c \leq ( 2 * Cable OD )$$

where c is the depth of the roller groove.

In another example embodiment, the tension measuring device may be configured wherein a depth of the roller groove when used in the smooth jacketed cable is as follows:

$$( 0.8 * Cable OD ) \leq c \leq ( 1. 2 * Cable OD )$$

where c is the depth of the roller groove.

In another example embodiment, the tension measuring device may be configured wherein a contact angle between a cable outer diameter and a cable inner diameter of the roller groove is as follows:

$$100 ° \leq d \leq 180 °$$

where d is the cable inner diameter.

In another example embodiment, the tension measuring device may be configured wherein a contact angle between a cable outer diameter and a cable inner diameter of the roller groove when used in the smooth jacketed cable is as follows:

$$120 ° \leq d \leq 180 ° .$$

where d is the cable inner diameter.

In another example embodiment, a roller is described. The roller may comprise a body configured in a round shape, the body having an external edge with a groove, the groove having a size according to one of:

$$( Cable OD - 0.007 ” ) \underline{<} a \underline{<} ( Cable OD + 0.03 ” ) , ( 0.1 * Cable OD ) , ( Cable OD - 0.007 ” ) \underline{<} a \underline{<} ( Cable OD ) ;$$

and wherein a is an inner groove diameter.

In another example embodiment, the roller may be configured wherein a depth of the roller groove is as follows:

$$( 0.4 * Cable OD ) \leq c \leq ( 2 * Cable OD )$$

where c is the depth of the roller groove.

In another example embodiment, the roller may be configured wherein a depth of the roller groove when used in the smooth jacketed cable is as follows:

$$( 0.8 * Cable OD ) \leq c \leq ( 1. 2 * Cable OD )$$

where c is the depth of the roller groove.

In another example embodiment, the roller may be configured wherein the roller is made of one of stainless steel, high carbon steel, steel, and cast iron.

In another example embodiment, the roller may be configured wherein the roller is made of one of aluminum and cast aluminum.

In another example embodiment, the roller may further comprise a bearing placed within the body.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A tension measuring device, comprising:
a first roller,
a second roller, the first roller and the second roller each having a body wherein a groove size is provided as one of follows:
$$( Cable OD - 0.007 ” ) \underline{<} a \underline{<} ( Cable OD + 0.03 ” ) , ( 0.1 * Cable OD ) , ( Cable OD - 0.007 ” ) \underline{<} a \underline{<} ( Cable OD ) ;$$
and
a load cell connected between the first roller and the second roller and the value a is an inner groove diameter.

2. The tension measuring device according to claim 1, wherein the first roller and the second roller are configured to be used with a smooth jacketed cable.

3. The tension measuring device according to claim 1, wherein an opening angle of the groove is as follows:
$$0 ° \leq b \leq 60 ° .$$

4. The tension measuring device according to claim 1, wherein a depth of the roller groove is as follows:
$$( 0.4 * Cable OD ) \leq c \leq ( 2 * Cable OD )$$
where c is the depth of the roller groove.

5. The tension measuring device according to claim 1, wherein a depth of the roller groove when used in the smooth jacketed cable is as follows:
$$( 0.8 * Cable OD ) \leq c \leq ( 1.2 * Cable OD ) .$$

6. The tension measuring device according to claim 1, wherein a contact angle between a cable outer diameter and a cable inner diameter of the roller groove is as follows:
$$100 ° \leq d \leq 180 ° .$$

7. The tension measuring device according to claim 1, wherein a contact angle between a cable outer diameter and a cable inner diameter of the roller groove when used in the smooth jacketed cable is as follows:
$$120 ° \leq d \leq 180 ° .$$

8. A tension measuring device, comprising:
a first roller,
a second roller,
a third roller, the first roller, the second roller and the third roller each having a body wherein a groove size is provided as one of follows:
$$( Cable OD - 0.007 ” ) \underline{<} a \underline{<} ( Cable OD + 0.03 ” ) , ( 0.1 * Cable OD ) , ( Cable OD - 0.007 ” ) \underline{<} a \underline{<} ( Cable OD ) ;$$
a load cell connected between the first roller and the second roller wherein the value a is an inner groove diameter.

9. The tension measuring device according to claim 8, wherein the first roller and the second roller are configured to be used with a smooth jacketed cable.

10. The tension measuring device according to claim 8, wherein an opening angle of the groove is as follows:
$$0 ° \leq b \leq 60 °$$
where b is the opening angle.

11. The tension measuring device according to claim 8, wherein a depth of the roller groove is as follows:
$$0.4 * Cable OD \leq c \leq ( 2 * Cable OD )$$
where c is the depth of the roller groove.

12. The tension measuring device according to claim 8, wherein a depth of the roller groove when used in the smooth jacketed cable is as follows:
$$0.8 * Cable OD \leq c \leq ( 1.2 * Cable OD )$$
where c is the depth of the roller groove.

13. The tension measuring device according to claim 8, wherein a contact angle between a cable outer diameter and a cable inner diameter of the roller groove is as follows:
$$100 ° \leq d \leq 180 °$$
where d is the cable inner diameter.

14. The tension measuring device according to claim 8, wherein a contact angle between a cable outer diameter and a cable inner diameter of the roller groove when used in the smooth jacketed cable is as follows:
$$120 ° \leq d \leq 180 ° .$$
where d is the cable inner diameter.

15. A roller, comprising:
a body configured in a round shape, the body having a external edge with a groove, the groove having a size according to one of:
$$( Cable OD - 0.007 ” ) \underline{<} a \underline{<} ( Cable OD + 0.03 ” ) , ( 0.1 * Cable OD ) , ( Cable OD - 0.007 ” ) \underline{<} a \underline{<} ( Cable OD ) ;$$
and wherein a is an inner groove diameter.

16. The roller according to claim 15, wherein a depth of the roller groove is as follows:
$$0.4 * Cable OD \leq c \leq ( 2 * Cable OD )$$
where c is the depth of the roller groove.

17. The roller according to claim 15, wherein a depth of the roller groove when used in the smooth jacketed cable is as follows:
$$( 0.8 * Cable OD ) \leq c \leq ( 1.2 * Cable OD )$$
where c is the depth of the roller groove.

18. The roller according to claim 15, wherein the roller is made of one of stainless steel, high carbon steel, steel, cast iron.

19. The roller according to claim 15, wherein the roller is made of one of aluminum and cast aluminum.

20. The roller according to claim 15, further comprising a bearing placed within the body.
